(19) United States
(12) Patent Application Publication
(10) Pub. No.: US 2007/0190859 A1
(43) Pub. Date: Aug. 16, 2007

(54) Nut part insertable into a penetration in a metal plate

(75) Inventors: Eberhardt Christ, Tambach-Dietharz (DE); Marko Goring, Gotha (DE)

Correspondence Address: BIRCH STEWART KOLASCH & BIRCH, PO BOX 747, FALLS CHURCH, VA, 22040-0747, US

(73) Assignee: EJOT GmbH & Co. KG, Bad Laasphe (DE)

(21) Appl. No.: 11/703,744

(22) Filed: Feb. 8, 2007

(30) Foreign Application Priority Data
Feb. 10, 2006 (DE) 20 2006 002 173.6

(51) Int. Cl. H01R 9/03

(52) U.S. Cl. 439/610

(57) ABSTRACT

The invention relates to a rotationally symmetrical plastic nut part, insertable into a penetration in a metal plate, for a fastener, more particularly a screw, adapted to be received by a hole in the nut part, with a flange, said flange being adapted to be brought into contact with the metal plate. A coaxial metal ring is embedded in the flange, a front side of said metal ring being adapted to be brought into contact with the surface of the metal plate, wherein, upon rotation of the nut part together with the metal ring, the metal ring is adapted to be joined by friction-welding to the metal plate.

The invention relates to a plastic nut part, insertable into a penetration in a metal plate, for a fastener, more particularly a screw, adapted to be received by a hole in the nut part, with a flange, said flange being adapted to be brought into contact with the metal plate.

Such nut parts are known in various designs. They may be screwed into the penetration in the metal plate; alternatively, it is possible for the nut part to be glued in place. Also known are nut parts which, after insertion into the penetration in the metal plate, are secured to the metal plate by expandable snap-in hooks. Such a nut part is presented and described, for example, in DE 103 05 610 A1.

Said known connections between metal plate and nut part have only a limited loading capacity. However, there are applications in which such a nut part is required to be joined to the metal plate with particular strength. This problem is solved by the invention in that a coaxial metal ring is embedded in the flange, a front side of said metal ring being adapted to be brought into contact with the surface of the metal plate, wherein, upon rotation of the nut part together with the metal ring, the metal ring is adapted to be joined by friction-welding to the metal plate.

The friction-welded connection between the metal ring and the metal plate is capable of absorbing considerable forces, because the friction-welded connection establishes a particularly strong connection. Since the metal ring is embedded in the nut part, the nut itself has a correspondingly strong connection to the metal plate.

There are various possibilities for the embedding of the metal ring in the plastic of the nut part and for the design of the metal ring. A simple design consists in that a coaxial collar of the metal ring projects out of the flange, said collar being adapted to be brought into friction-welding contact with the plate. When the nut part is rotated in relation to the metal plate, the collar rubs against the surface of the metal plate and, with appropriate rotation, is joined to the metal plate by means of a friction-welded connection. The collar may be disposed at the inside edge of the metal ring; alternatively, however, it is possible for the collar to be disposed at the outside edge of the metal ring.

The collar may be variously oriented. On the one hand, it is possible for the collar to be of such design that it is oriented in the screwing-in direction of the fastener. However, it is also possible for the collar to be oriented opposite to the screwing-in direction of the fastener. In the former case, the flange, which is adapted to contact the metal plate, engages the upper side thereof, with the result that the flange is accessible on that side. If the collar is oriented opposite to the screwing-in direction of the fastener, the flange contacts the lower side of the metal plate, with the result that the component which is to be joined to the metal plate is pressed by the fastener against the upper side of the metal plate.

Furthermore, the collar may be of various designs. For example, it is possible for the collar to be of cylindrical design. Alternatively, however, it is possible for the collar to be of conical design. In the case of a collar of cylindrical form, there is a friction-welding surface which corresponds to the cross-section of the collar. In the case of a conical collar, the conical collar is introduced into the penetration in the metal plate, this resulting, through the thickness thereof and through any pull-through formed during production of the penetration, in a larger contact surface between collar and metal plate and, therefore, in a wider zone of the friction-welded connection.

The metal ring may be so embedded in the nut part that the flange of the nut part largely surrounds the metal ring, wherein penetrations in the metal ring ensure that the metal ring does not cause any separation of plastic material within the nut part. The plastic of the nut part is continued in the penetrations in the metal ring, this ensuring that the metal ring does not result in any division of the plastic material over the entire length of the metal ring. A further variation on the design of the metal ring consists in that the metal ring surrounds the nut part with interruptions and, with an interrupted collar, projects out of the flange opposite to the screwing-in direction without any separation of plastic material. In this case, the nut part is embraced, in its region projecting into the penetration in the metal plate, by the metal ring, wherein the collar of the metal ring—which collar projects with interruptions out of the flange of the nut part—provides the possibility of being used for a friction-welded connection, more specifically for a friction-welded connection in which the metal ring projects out of the flange opposite to the screwing-in direction.

In order to set the nut part in rotation in the penetration in the metal plate, the nut part may advantageously be of such design that the flange forms a hexagon. In this case, the hexagon may serve for the application of a screwing tool by means of which the nut part can be rotated in the penetration in the metal plate. It is also possible for the nut part to be provided with a socket for an insertion tool, e.g. a socket for an allen key, in order to produce the required torque upon rotation of the nut part in the penetration in a metal plate.

It is also possible for the nut part itself to be in the form of a polygon which, in this case, can be engaged directly by a screwing tool.

A further possibility for advantageously setting the nut part in rotation with the metal ring consists in that the metal ring itself is polygonal in form. In this case, the metal ring may serve to receive a torque as the nut part is being screwed into the metal plate.

Illustrative embodiments of the invention are presented in the drawings, in which:

FIG. 1 shows the nut part with a metal ring embedded in its flange;

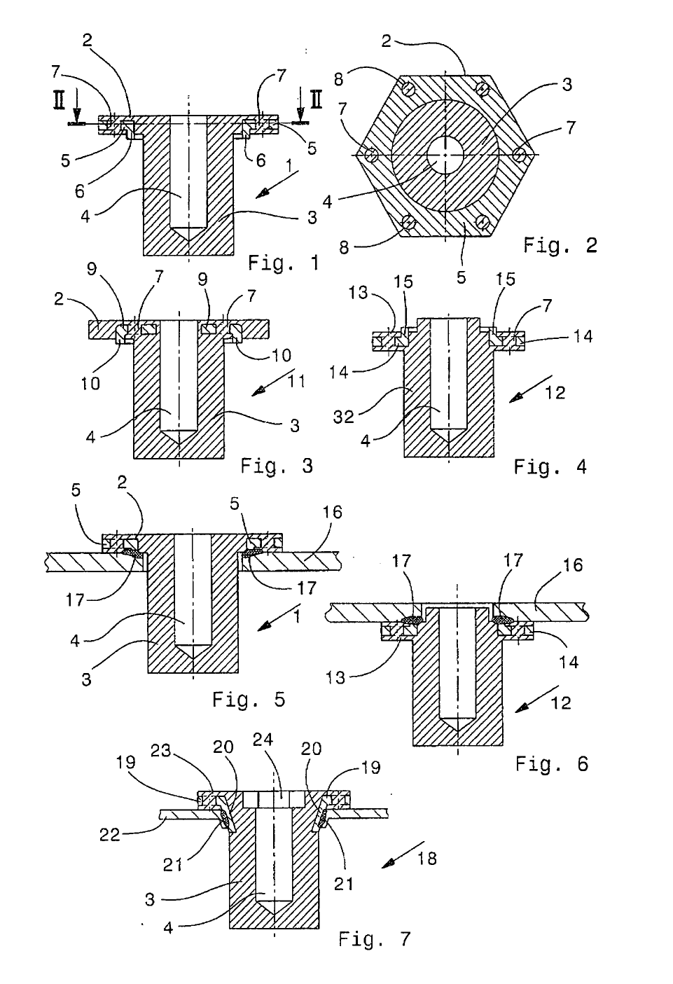

FIG. 2 shows a top plan view of the design according to FIG. 1, as a section along line II-II;

FIG. 3 shows a variation on the design according to FIG. 1;

FIG. 4 shows a further design of the nut part;

FIG. 5 shows the nut part from FIG. 1 with a friction-welded connection to a metal plate, the flange of the nut part being in contact with the upper side of the metal plate;

FIG. 6 shows a connection between nut part and metal plate as in FIG. 4 in which the flange is in contact with the lower side of the metal plate;

FIG. 7 shows the nut part with a metal ring and conical collar;

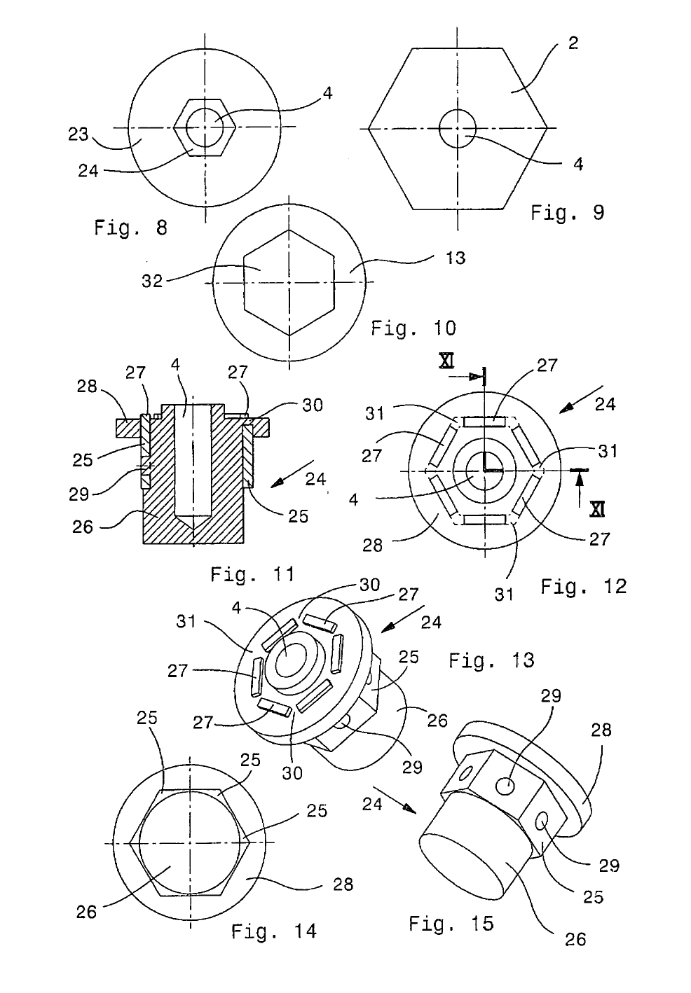

FIG. 8 shows a top plan view of the design according to FIG. 7 with a hexagonal socket for application of a corresponding tool;

FIG. 9 shows a top plan view of the nut part from FIG. 1 with a flange in the form of a hexagon;

FIG. 10 shows a view of the design according to FIG. 4 from the side of the nut part facing away from the flange;

FIG. 11 shows the nut part with a metal ring surrounding the nut part, with an interrupted collar of said metal ring projecting out of the flange;

FIG. 12 shows a top plan view of the design according to FIG. 11;

FIG. 13 shows a perspective view of the nut part according to FIG. 12;

FIG. 14 shows a view of the design according to FIG. 11 from the side of the nut part facing away from the flange;

FIG. 15 shows a perspective view of the nut part according to FIG. 14.

FIG. 1 presents the nut part 1 with its flange 2 and its body 3, in which body 3 is formed the hole 4. The hole 4 may serve, for example, to receive a self-tapping threaded screw. Embedded in the flange 2 is the metal ring 5, which is provided with the collar 6. The collar 6 projects out of the lower side of the flange 2 and serves to be joined to a metal plate by friction-welding, which operation will be discussed in greater detail hereinbelow. So that the metal ring 5 does not divide the flange 2 into two parts devoid of any connection to each other, the metal ring 5 is provided with holes which, in FIG. 1, are filled with the plastic bridges 7 and which join together the upper side and lower side of the flange 2.

In order to illustrate the design of the nut part 1 according to FIG. 1, FIG. 2 presents a section along line II-II from FIG. 1. It is apparent from this sectional representation how the upper side and lower side of the flange 2 as presented in FIG. 1 are joined together by the plastic bridges 7. The plastic bridges 7 fill holes 8 in the metal ring 5, said holes 8 being provided for production of the plastic bridges 7.

In FIG. 1, the collar 6 of the metal ring 5 is disposed at the inside edge of the metal ring 5.

FIG. 3 presents a variation on the design according to FIGS. 1 and 2 in which the metal ring 9, which is generally embedded in the flange 2, is provided with the collar 10 at its outside edge. As for the rest, the metal ring 9 is provided, as in the design according to FIGS. 1 and 2, with holes which are filled by plastic bridges 7, the upper and lower sides of the flange 2 being joined together by said plastic bridges 7. Otherwise the design of the nut part 11 is identical to that of the nut part 1 according to FIGS. 1 and 2.

In the illustrative embodiments presented in FIGS. 1-3, the collar projects out of the lower side of the flange 2 in the screwing-in direction of a screw which is insertable into the hole 4.

FIG. 4 presents a similar design of a nut part 12 in which the metal ring 14 is embedded in the flange 13. The metal ring 13 is provided at its inside edge with the collar 15, which projects out of the upper side of the flange 13.

FIG. 5 presents the plastic nut 1 together with the metal plate 16, wherein metal plate 16 and flange 2 of the plastic nut 1 have been joined together by friction-welding, the friction-welded connection being here identified by reference character 17. In this case, the connection between metal ring 5 and metal plate 16 is made on the lower side of the flange 2, which is in contact with the upper side of the metal plate 16.

FIG. 6 likewise presents a connection between nut part 12 and metal plate 16, the connection between the metal ring 14 and the metal plate 16 being made on the upper side of the flange 13, the flange 13 being in contact with the lower side of the metal plate 16.

FIG. 7 presents a variation on the hereinbefore described designs of nut part with metal ring in which the metal ring 19 is provided with a conical collar 20. The conical collar 20 results in a strong friction-welded connection in the region 21, since, in the region 21, the conical collar 20 is welded, as it were, into the penetration in the metal plate 22.

With regard to the hereinbefore presented connections between nut part and metal plate, it is pointed out that, in all cases, the nut part has been inserted into the penetration in a metal plate and the nut part has been set in rotation by some tool, this then resulting, in the region of the presented friction-welded connections, in corresponding heating and, therefore, in a friction-welded connection.

The nut part 18 according to FIG. 7 is provided in the region of its flange 23 with a hexagonal socket 24 for receiving a similarly hexagonal insertion tool (allen key), which serves, on the one hand, to exert a friction pressure via the nut part 18 on a mating component, namely (in FIG. 7) the metal plate 22, this then resulting in the friction-welded connection 21. The hexagonal socket 24 according to FIG. 7 is likewise clearly presented in a top plan view in FIG. 8.

FIG. 9 presents a top plan view of the design according to FIG. 1 and FIG. 2 in which the flange 42 is hexagonal in form. For screwing the nut part 1 or 11 into the penetration in a metal plate, the flange 2 of the nut part 1 or 11 is hexagonal in form and can therefore be received and set in rotation by an appropriate tool.

FIG. 10 presents a design of the nut part in which the body 32 itself is hexagonal in form and in which, therefore, an appropriate tool can be used as the mating component. FIG. 10 presents a top plan view of the lower side of the flange 13 from FIG. 4.

FIG. 11 presents a nut part 24, said nut part 24 being provided with a metal ring 25 which surrounds the body 26 of the nut part 24 and, as metal ring 25, serves to transmit the torque for rotation of the nut part 24. The metal ring 25 penetrates the flange 28 with individual teeth 27, this ensuring that the flange 28 forms an entity with the body 26. In order to ensure that the metal ring 25, surrounding the body 26, is securely held on the body 26, the body 26 is provided with penetrations 29 which are filled with plastic of the nut part 24 and which, therefore, establish a torque-proof connection between metal ring 25 and body 26. The flange 28 is provided with a number of penetrations 30, which ensure that the outside of the flange 28 is not separated from the body 26.

The design of the teeth 27 from FIG. 11 is also clearly shown in the top plan view in FIG. 12, which presents both the teeth 27 and the therebetween situated plastic bridges 31.

The design of the nut part 24 with the metal ring 25 is presented particularly clearly in the perspective view in FIG. 13.

FIG. 14 presents the nut part from FIG. 11 in a top plan view of the lower side of the body 26. As presented, the metal ring 25 is hexagonal in form to allow it to be engaged directly by an tool.

FIG. 15 presents a perspective view of the metal ring from FIG. 11 and clearly shows the body 26 of the metal ring 25. Here, as was presented in connection with FIG. 14, the metal ring is hexagonal in form. The individual hexagon-forming surfaces of the metal ring 25 are here penetrated by the penetrations 29, into which penetrations 29 plastic material from the body 26 has penetrated, thereby establishing the torque-proof connection between metal ring 25 and body 26.

1. Rotationally symmetrical plastic nut part (1, 11, 12, 18, 24), insertable into a penetration in a metal plate (16, 22), for a fastener, more particularly a screw, adapted to be received by a hole (4) in the nut part (1, 11, 12, 18, 24), with a flange (2, 13, 23, 28), said flange (2, 13, 23, 28) being adapted to be brought into contact with the metal plate (16, 22), characterized in that a coaxial metal ring (5, 9, 14, 19, 25) is embedded in the flange (2, 13, 23, 28), a front side of said metal ring (5, 9, 14, 19, 25) being adapted to be brought into contact with the surface of the metal plate (16, 22), wherein, upon rotation of the nut part (1, 11, 12, 18, 24) together with the metal ring (5, 9, 14, 19, 25), the metal ring (5, 9, 14, 19, 25) is adapted to be joined by friction-welding to the metal plate (16, 22).

2. Nut part according to claim 1, characterized in that a coaxial collar (6, 10) of the metal ring (5, 9) projects out of the flange (2), said collar (6, 10) being adapted to be brought into friction-welding contact with the metal plate.

3. Nut part according to claim 2, characterized in that the collar (6) is disposed at the inside edge of the metal ring (5).

4. Nut part according to claim 2, characterized in that the collar (10) is disposed at the outside edge of the metal ring (9).

5. Nut part according to claim 2, characterized in that the collar (6, 10) is oriented in the screwing-in direction of the fastener.

6. Nut part according to claim 2, characterized in that the collar (15) is oriented opposite to the screwing-in direction of the fastener.

7. Nut part according to claim 2, characterized in that the collar (6, 10, 15) is cylindrical.

8. Nut part according to claim 2, characterized in that the collar (20) is conical.

9. Nut part according to claim 1, characterized in that the metal ring (5, 9) is provided with penetrations (7), wherein, in the embedded position, said penetrations (7) are penetrated by the material of the flange (2).

10. Nut part according to claim 1, characterized in that the flange (2) forms a hexagon.

11. Nut part according to claim 1, characterized in that the nut part (18) is provided with a socket (24) for an insertion tool.

12. Nut part according to claim 1, characterized in that the body (32) is polygonal in form.

13. Nut part according to claim 1, characterized in that the metal ring (25) surrounds the nut part (24) with penetrations (29; 30) and projects in a collar (27) on the flange (28) opposite to the screwing-in direction.

14. Nut part according to claim 12, characterized in that the metal ring (25) surrounds the nut part (24) and is polygonal in form.

15. Nut part according to claim 3, characterized in that the collar (6, 10) is oriented in the screwing-in direction of the fastener.

16. Nut part according to claim 4, characterized in that the collar (6, 10) is oriented in the screwing-in direction of the fastener.

17. Nut part according to claim 3, characterized in that the collar (15) is oriented opposite to the screwing-in direction of the fastener.

18. Nut part according to claim 4, characterized in that the collar (15) is oriented opposite to the screwing-in direction of the fastener.

19. Nut part according to claim 3, characterized in that the collar (6, 10, 15) is cylindrical.

20. Nut part according to claim 4, characterized in that the collar (6, 10, 15) is cylindrical.
